(19) United States
(12) Patent Application Publication
(10) Pub. No.: US 2009/0064938 A1
(43) Pub. Date: Mar. 12, 2009

(54) Extended time low-tech animal feeder

(76) Inventor: Michael Or, Sacramento, CA (US)

Correspondence Address: Mark C. Jacobs, Esq., 3033 EI Camino Ave., Sacramento, CA, 95821, US

(21) Appl. No.: 11/899,947

(22) Filed: Sep. 10, 2007

(51) Int. Cl. A01K 5/02

(52) U.S. Cl. 119/51.5

(57) ABSTRACT

A plural day gravity fed animal feeding and watering apparatus. The non-electric apparatus has compartments for food and water. A timer that uses the principle of wicking action permits food and water to enter respective dishes. Alternatively, mass reduction via disposition of water in a bored container can deliver water to the water bowl. The mass of water disposed in a container is to be reduced by the wicking action to reduce fluid mass. For food delivery, the mass of water holds an impact plate upward but when the mass is reduced by the wicking action, the weight will discontinue hold up the impact plate and a gap opens thereby allowing food to exit through the apparatus into the food dish. Selection of wicks controls the time period before the gap opens. Each distinct areas for dispensing food or drink can be controlled separately by the proper choice of wick.

### FIELD OF THE INVENTION

This invention relates to an apparatus for feeding and providing water to animals over an extended period of time during one's absence.

### BACKGROUND OF THE INVENTION

With the high cost of kennels and doggy hotels, and the limited availability of animal feeding companies, people find that there is a need for the ability to feed animals during extended periods of time away from their pet. These periods include holiday visits, vacation, business trips and during periods of illness of themselves or a loved one. Indeed a review of the patent literature shows that many different electrically operated animal feeders have been conceived, and there are many animal watering devices available using different operating principles. Many of these work for a night or two, while others operate over a longer period. But what if the power goes out? Then Fido or Fluffy will go hungry and/or thirsty. Thus there is a need for a low-tech non-powered extended-period animal feeder and waterer apparatus that is light weight, portable and easy to use. This apparatus fills the recited needs for a combination extended period of use animal feeder and waterer.

For a fuller understanding of the nature and objects of the invention, reference should be made to the following detailed description, taken in conjunction with the accompanying drawings.

### SUMMARY OF THE INVENTION

A portable low-tech easy-to-use animal feeder and waterer that operates without the need for electricity over a controllable period of time that uses the wicking of water as a timing device to cause a pre-measured amount of food to be released into a dish to be accessed for consumption by a dog or cat or other small animal. Timed-release water is delivered to a separate bowl for access by the animal. Food is released from a bin to drop down an inclined plane into a food receiving area which further delivers the food by gravity into a bowl for consumption. Water is released into a water receiving bowl from which it is transferred by gravity to a water accessing bowl for animal consumption.

It is an object of this invention to provide a low-tech non-electric animal waterer and feeder for use over extended periods of time.

It is another object to provide an apparatus for feeding animals and providing water to them over an extended period of time.

It is a third object to provide a feeder/waterer whose operation as to start time can be controlled mechanically by certain predeterminations.

It is a fourth object to provide an animal feeder and watering apparatus that can be setup to release food over a predefined time period.

It is a fifth object to provide an easy to clean animal feeding and watering apparatus.

It is a sixth object to provide an animal feeding and animal water-providing apparatus that operates by gravity.

Other objects of the invention will in part be obvious and will in part appear hereinafter.

### BRIEF DESCRIPTION OF FIGURES

FIG. 1 is a right side perspective view of the first embodiment of the animal feeder-waterer of this invention.

FIG. 2 is a rear perspective view thereof.

FIG. 3 is a top perspective view with the lid also known as the top open.

FIG. 4 is a perspective view of a water vessel used with this invention.

FIG. 5 is a top closeup perspective view showing the disposition of a water vessel in embodiment 1.

FIG. 6 is a closeup perspective view of a mounted second retainer assembly that holds a water vessel.

FIG. 7 is a top interior view of the upper body of this invention's first embodiment.

FIG. 8 is a closeup perspective view of a part of the upper interior body with water vessel in place in the first embodiment.

FIG. 9 is a view similar to FIG. 8 but without the water vessel.

FIG. 10 is a front perspective view of the outside lower body of this apparatus.

FIG. 11 is a top perspective view of the interior of the lower body.

FIG. 12 is a side perspective view of the interior lower body of this animal feeder-waterer.

FIG. 13 is a closeup top perspective view of a portion of the interior of the upper body.

FIG. 14 is a bottom perspective view of the body of the invention's first embodiment from a top vantage point.

FIG. 15 is a side bottom perspective view of the body of this feeder/waterer.

FIG. 16 is a top rear perspective view of the interior of the lower body of this apparatus.

FIG. 17 is a bottom plan view of the upper body of this invention.

FIG. 18 is a closeup top perspective view with one water vessel in position for use and one water vessel is absent.

FIG. 19 is a perspective view of the tray utilized to hold the lower body of the invention and to receive water as well.

FIG. 20 is a left side perspective view of the lower body of this invention's first embodiment.

FIG. 21 is a rear perspective view of the lower body of this invention.

FIG. 22 is a top slightly perspective view of the upper body of this apparatus.

FIG. 23 is a closeup perspective view of a first retainer assembly and a vessel deployed therein with its wick and weight.

FIG. 24 is a front cutaway view in the format of an engineering drawing too illustrate the operation of this apparatus, and to present a second embodiment.

FIG. 25 is a top perspective view of the second embodiment interior.

FIG. 26 is a closeup view of two elements seen in FIG. 25.

FIG. 27 is a perspective view of the food delivery element, which constitutes a combination of several elements from the first embodiment.

FIG. 28 is a bottom plan view of the second embodiment.

### DESCRIPTION OF THE PREFERRED EMBODIMENT

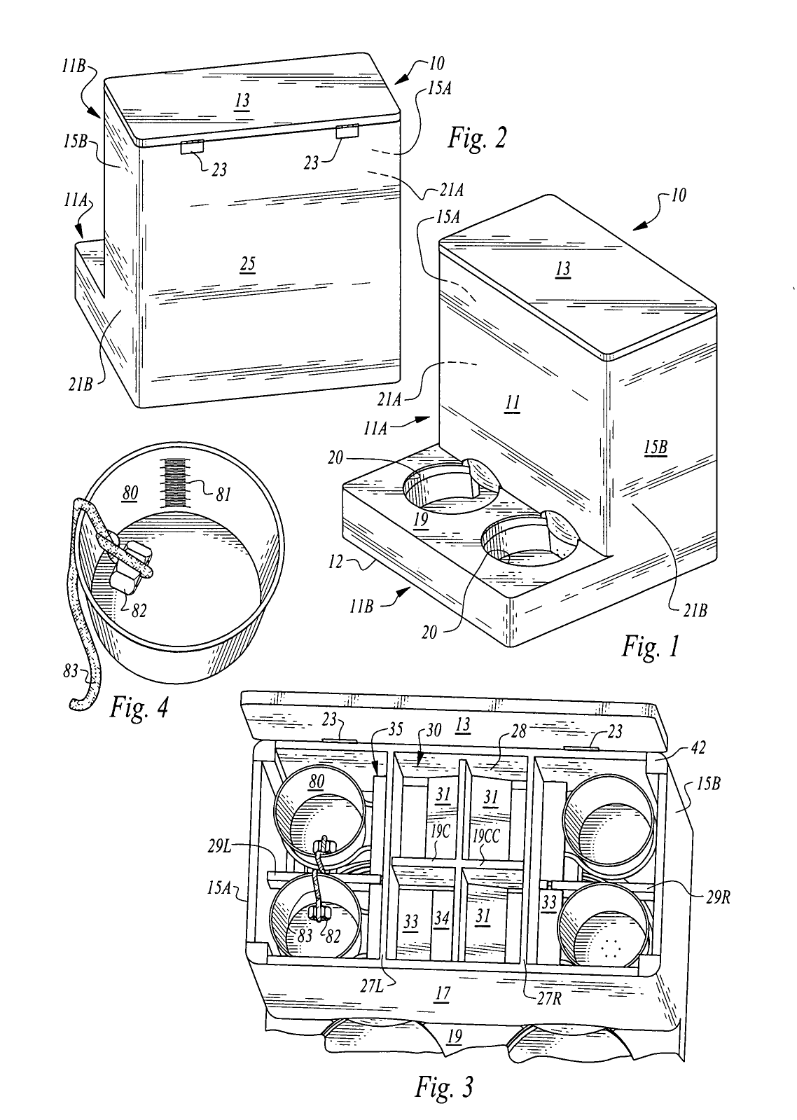

FIG. 1 is a perspective view of the first embodiment of this apparatus of this invention, 10. The apparatus has an upper body 11A and a lower body, 11B. The upper body will be described first. The apparatus 10 has a pair of spaced side walls 15A and 15B, The back wall 25 is seen in FIG. 2, A top wall 13 is hingedly connected to the back wall by hinges 23. A front wall 17 is spaced from the back wall and is connected between the two side walls 15A and 15B. Optional round corner bracing can be employed for both strength and aesthetics at all four corners where the front and rear panels meet the sides.

The lower body 11B has spaced side walls 21A and 21B of spacing equal to that of the upper body side walls 11A & 11B and each lower body sidewall may be integrally formed with the upper body side wall as may be desired. As can be seen from FIG. 2, The back wall extends the full length of both the upper and lower bodies. The front wall 22 is seen in both FIGS. 1 and 17 and it is connected at the front edge of said lower side walls to both of the spaced lower body side walls. Note that the lower body side walls extend forwardly of the side walls of the upper body. An access shelf 19 extends forwardly from the base of the front of the upper body to the top edge of the front of the lower body. The access shelf 19 is coextensive with the side walls of the apparatus laterally. A pair of spaced preferably round cutouts 20 provide access to both a water bowl and a feed bowl, both of which will be discussed infra.

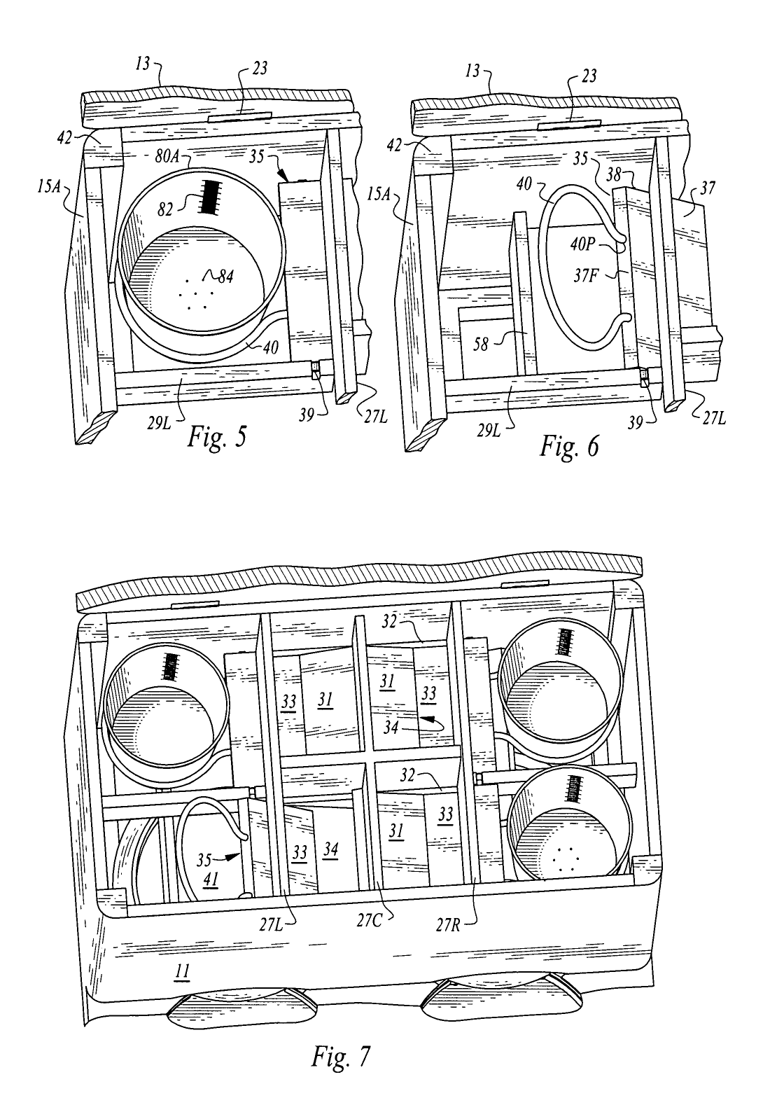

The discussion now turns to FIG. 3, which is a top perspective view of the interior of the upper body of this embodiment. As can be seen the space between the two side walls 15 A & B is divided into three major sections of about the same size from left to right. The middle section is divided in half. The left section is laterally defined by the left side wall 15A and the left stabilizer-divider, hereinafter to abbreviated as (S-D), here (S-D) 27L. A spaced (S-D) is disposed inwardly an equal amount from right side wall 15B to define the right chamber. That (S-D) is designated 27R. While the (S-D) that extends downwardly vertically part way toward the lower body that is in the middle is designated 27C for central. The upper edge of each of the outer (S-Ds) is the upper edge of the front and rear walls, while the center stabilizer-divider commences spaced down from the top edges of the front and rear walls of the upper body. Each of the two outer (S-D)s extend downwardly to an impact shelf 33 that is part of the assembly 35. The impact shelf is disposed normal to the (S-D) and butts up to it when the vessels with the first wicking means defined as a wick and attached to a weight, have water or other fluid such as milk therein. See FIG. 3. The movement of and structure of the first retainer assembly 35 will be discussed infra in the discussion of FIG. 6. Note that the (S-D)s 27L and 27R terminate just above the impact shelf 33, which extends outwardly beneath said respective (S-D) to be designated element 37. The overall designation is food hopper 30.

Lateral dividers 29C and 9CC normally bifurcate the central areas between the left and right (S-D)s. These lateral dividers preferably commence at an elevation equal to that of the (S-D) 27C Lateral dividers 29L and 29R are each spaced down even further from the top edge of the apparatus 10, and also extend laterally between their respective stabilizer-divider and a side wall to divide the outer areas into two chambers.

In three of the four central zones 28 that lie between the (S-D) 27L and 27R, an incline plane 31 diverges downwardly from the middle stabilizer-divider 27C. The incline plane of the left front zone 28, defined by 27L, 27C, 29C and the front wall 17 has had the incline plane 31 removed to reveal the space below each of the inclined planes 31. The space or opening that is visible in FIG. 3 is designated 34.

In each of the outer four chambers there is disposed a retainer assembly 35 one of which is seen up close in FIG. 6. Further discussion on the retainer assembly 35 will follow infra. In each first and second retainer assembly sits a water vessel 80 having content markings 82 scrawled or etched into the side wall. See FIG. 4 specifically. A simple plastic beaker wider at the top than at the bottom will suffice for each water vessel. Each of the two left vessels each carry a weight 82 such as a stainless steel or brass nut 82 to which is tied a cotton or other suitable material wick of a predetermined size. More on the sizing of the first and second wicking means infra. The reader should also note that the vessels on the right side of the apparatus specifically have a wick extending therefrom but are not seen in this view. Suffice it to say that the first wicking means are associated with the first vessels for food delivery and the second wicking means are for fluid or water delivery for drinking by the animal.

In FIG. 5, one of the vessels 80A used in the right side of the apparatus is shown. This vessel 80A also has volume markings thereon designated 82. In the base of the vessel, while here again can be a conventional polyethylene plastic beaker, a series of apertures 84 are seen. These permit any fluid placed in the vessel 80 to slowly drain out the bottom of the vessel. Due to cost considerations to drill tiny predefined apertures on a repetitive basis for commercial product quantities, the use of the wick as the fluid draining means is preferred here as well.

The reader is now referred to FIG. 6, where the front left section is seen, and specifically the first retainer assembly, 35. The first retainer assembly comprises a flat piece of wood, metal or plastic, a plate 37, which serves as a counterweight to the retainer ring 40, when said ring carries a vessel, which plate has a front face 37F and a pair of opposed pins 38 which are designated pivot points. An interrupted ring 40 having two points 40P are engaged by friction or retained by adhesive into bores not seen in face 37F.

As mentioned supra, plate 37 acts as a counter weight to loaded ring 40. Note the position of ring 40 in FIG. 3, it has swung upward since no vessel 80 or 80A is present. Contrast the position in FIG. 6 with the position of the ring 40 in FIG. 3. A view of FIG. 23 will show that the points 40P of ring 40 while directed straight into the face 37F of the plate 37, the rest of the ring 40 is canted. This plate 37 is seen to exist on both sides of the outer stabilizer divers 27A and 27C. The portion of plate 37 that serves as the impact shelf for food falling down is designated 33 and is disposed on the interior side of (S-D) 27L. Reference is made to the imaginary line 90 in FIG. 23. This explains why the impact shelf which was discussed previously has a lower designator number; namely, 33.

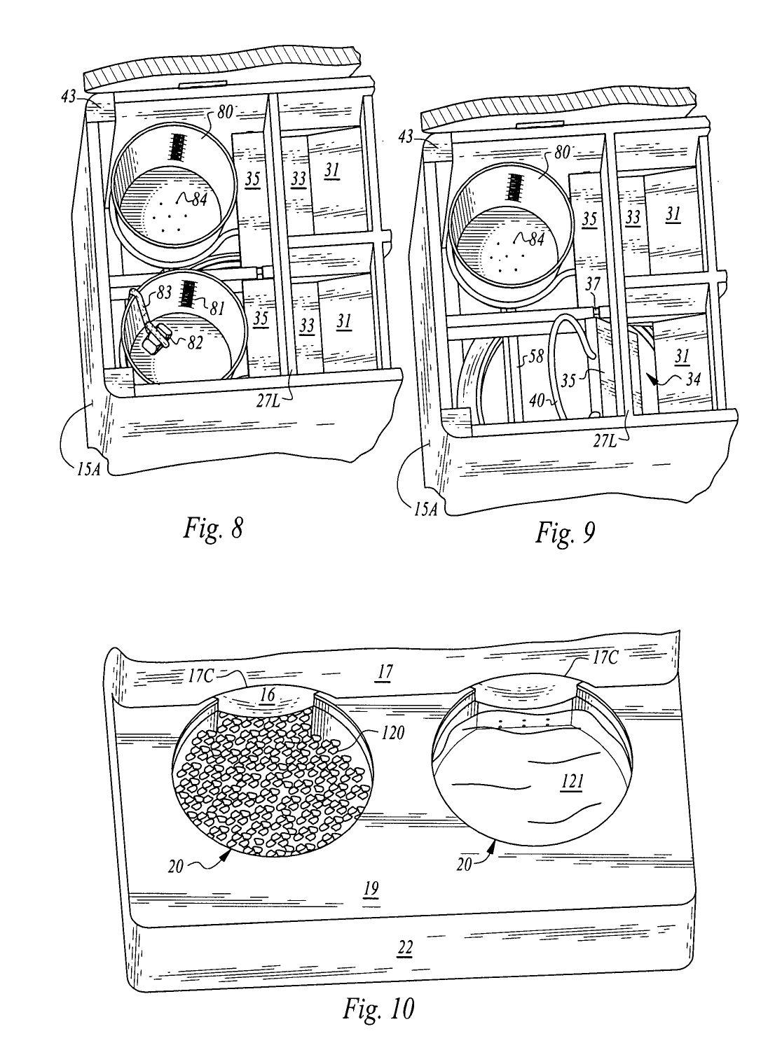

See FIG. 7 wherein the plate in the three areas where vessels are present. Here the left front vessel is missing and the impact shelf 33 is seen to have relocated downwardly due to the absence of vessel 80. Reinforcement of these points may be gleaned from FIG. 8 where the impact shelf 33 portion of pivot bar 37 is seen on both sides of stabilizer divider 27L. FIG. 8 also shows the corner brace 43 that can be employed for both aesthetic and structural integrity purposes, rather than having a butt joint of two sheets of wood or plastic or metal at the corner of the apparatus.

Reference is again made to FIG. 7 for space 34 which is the space below each of the incline planes 31. Space 34 is also seen in FIG. 9 since the counterweight has repositioned itself in the absence of a loaded vessel.

Wall 58 is a vertical wall disposed spaced from outside wall 15A and which may serve as a rest for vessel 80 when a vessel is disposed in ring 40. This wall 58 may be seen in FIGS. 6, 9, and 22 among others. It can be held in place by any conventional construction means. Wall 58 also serves to direct pellet animal feed into food receivers 16. Wall 58 commences from beneath lateral divider 29L and is normally disposed. Wall 58 terminates just above receivers 29 as per FIGS. 14 and 17.

The discussion now moves to the exterior of the apparatus. Thus, reference is made to FIG. 10. Here the access shelf 19 is seen normally disposed relative to lower front wall 22. A pair of circular cutouts 20 communicate indirectly with food dish and water bowl 36. The indirect communication will be discussed infra with respect to the elements beneath access shelf 19. Front wall 17 is seen to have a pair of spaced cutouts 17C, to accommodate the shape of quoit shaped annular members 16 which communicate with food receiver 42 and water receiver 42 respectively. These annular receivers 16 will be discussed relative to figure.

Also seen in FIG. 10 are food pellets 120 and liquid such as milk or water 121 in respective separate bowls. As can be seen, a portion of one quoit-shaped receiver overlies part of the respective cutout 20 which permits access by the animal to the food or liquid.

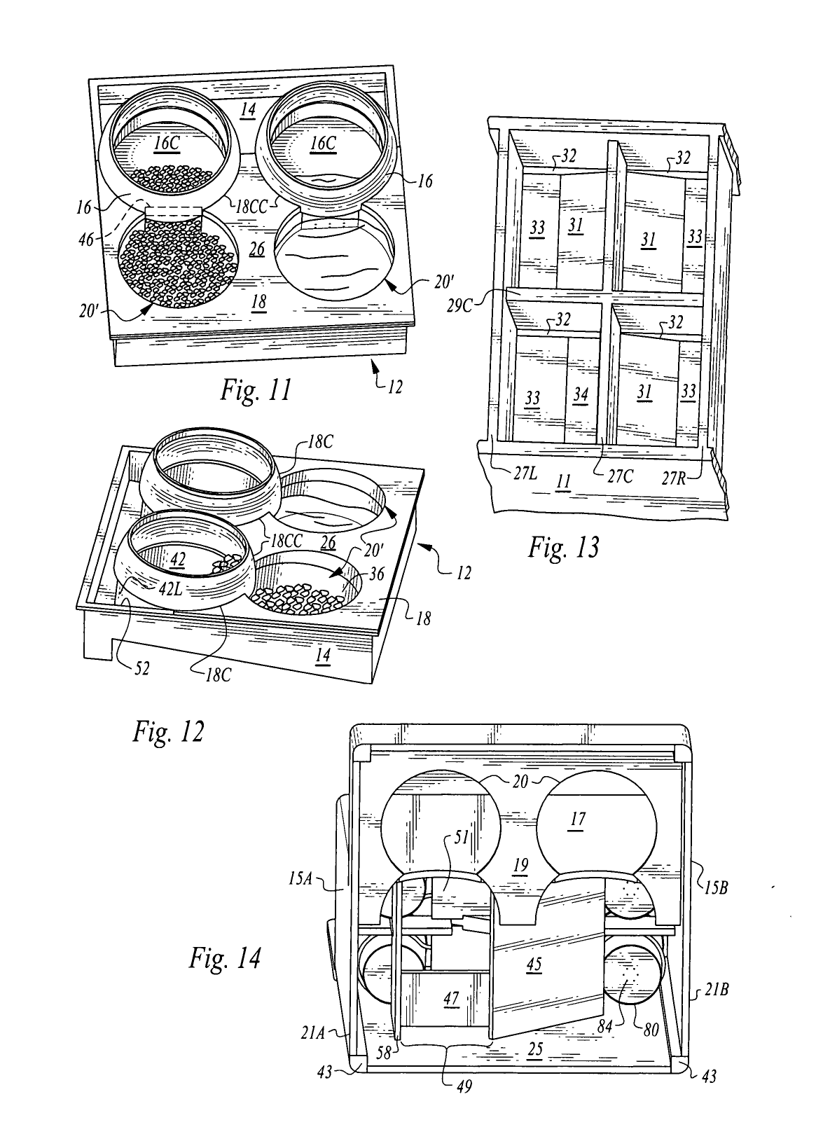

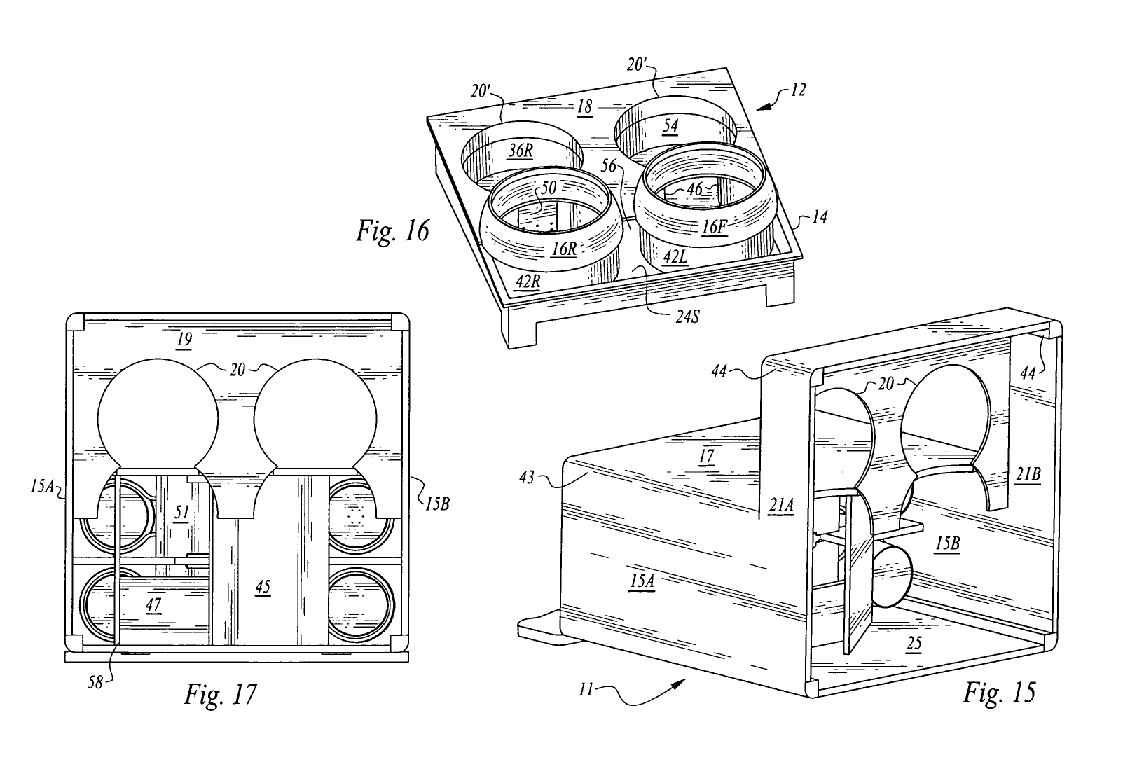

FIGS. 11,12 & 16 should all be viewed together. In FIG. 11, a top perspective view of the interior of the lower body, as well as in FIG. 12 a side perspective, one can see the “guts” of this apparatus which is designated as base 12 seen in FIG. 16 among others. Base 12 has front, rear and spaced side walls, open at the bottom and has a top surface 19 with a pair of cutouts 20 therein. Disposed beneath the base is a tray 14, which is a conventional plastic or metal painting tray with upstanding walls. Tray 14 is seen also in FIG. 19 wherein the ridged upper inclined surface 24 is seen, which surface leads to a lower planar horizontal section.

A pair of spaced side by side bowl like elements each support one of the quoit-shaped annular members 16 thereon. These bowl-like elements have a central opening 16C through which food and water flow respectively from up in the apparatus down to the respective food and water receiver 42 disposed beneath the member 16F. Food receiver 42L has an interrupted side wall where the bowl-like receiver 42 intersects dish 36 which also has an interrupted sidewall. Due to the interruptions, food can fall from the receiver 42 into the bowl 36. See also FIG. 16.

On the fluid side, only the wall of the annular member 16L, wherein L is for Liquid, is interrupted as can be seen in FIG. 10. The bowl like receiver 42R for the fluid has its side wall intact, but for the bores 50 which communicate with liquid bowl 26L. See FIG. 16.

Surround 18, seen in FIG. 20 and elsewhere is part of the support 51. The surround 18, is a planar member that is disposed beneath the access shelf 19 has similar cutouts 20′ which are sized and shaped similar to the cutouts 20 with which they communicate. That is openings 20 are respectively above openings 20′ because the surround 18 is disposed directly beneath the access shelf 19. The support 51 comprises the surround 18 which is supported by a W-shaped inside framework having a pair of spaced opposed sides 52—FIG. 12, a front or base member 54,—FIG. 16 and a center support frame member 56, whose edge is seen also in FIG. 16.

As can be seen the W-shaped frame, unnumbered since never shown as an entity in the figures, rests within the tray 14 to support surround 18, which optionally may be attached thereto by nails, staples, screws etc. The width of surround 18 is equal to the width of tray 14. The planar surround, 18, while having outer edges that are normal to its base, includes a pair of opposed mirror image leading arcuate edges 18C and a central section 26 with a pair of arcuate edges 18CC. The curvature of the arcuate edges 18C and 18CC is mated to the curvature of the quoit-like annular members 16 and serve as an alignment surface for the placement of the annular members 16 to butt up against.

Thus it is seen that as food drops down from the top, it enters receiver 42F through the annular member 16 disposed on top of the receiver and since the surface 24 of tray 14 slopes forwardly, the receivers therefore are disposed at an incline rather than flat. Thus the food pellets fall forwardly from the receiver 42F for food, into the bowl 36 adjacent thereto by gravity as well.

Fluid takes a similar path. It enters through opening 16C into the annular member 16 to reach its receiver 42L for liquid, which is also inclined due to the inclination of surface 24 upon which it rests. The fluid then flows through bores 50 into the liquid bowl 36L. See FIG. 21 as well which shows the pellets flowing into the food bowl and the fluid coming through the bores 50.

FIG. 13 is a top view of the center of this apparatus. The four zones 28 have previously been defined. This view being a bit close up shows the open space 34 below the impact plane 31 missing from the front left zone.

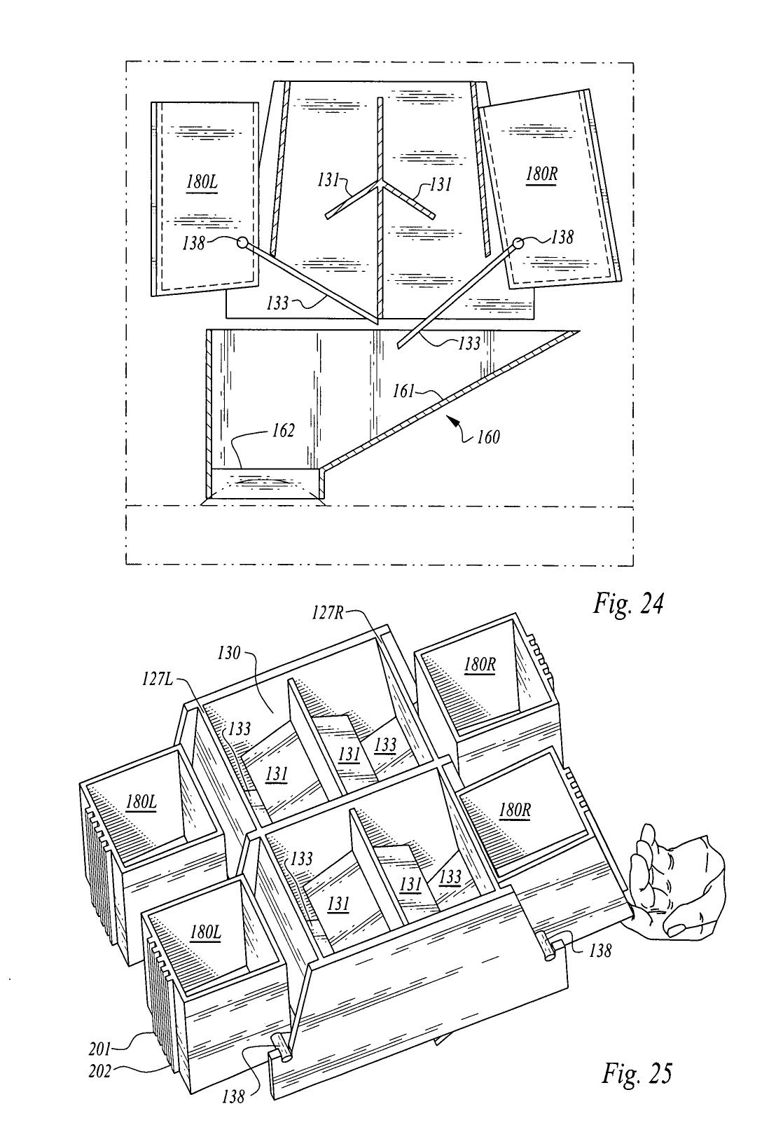

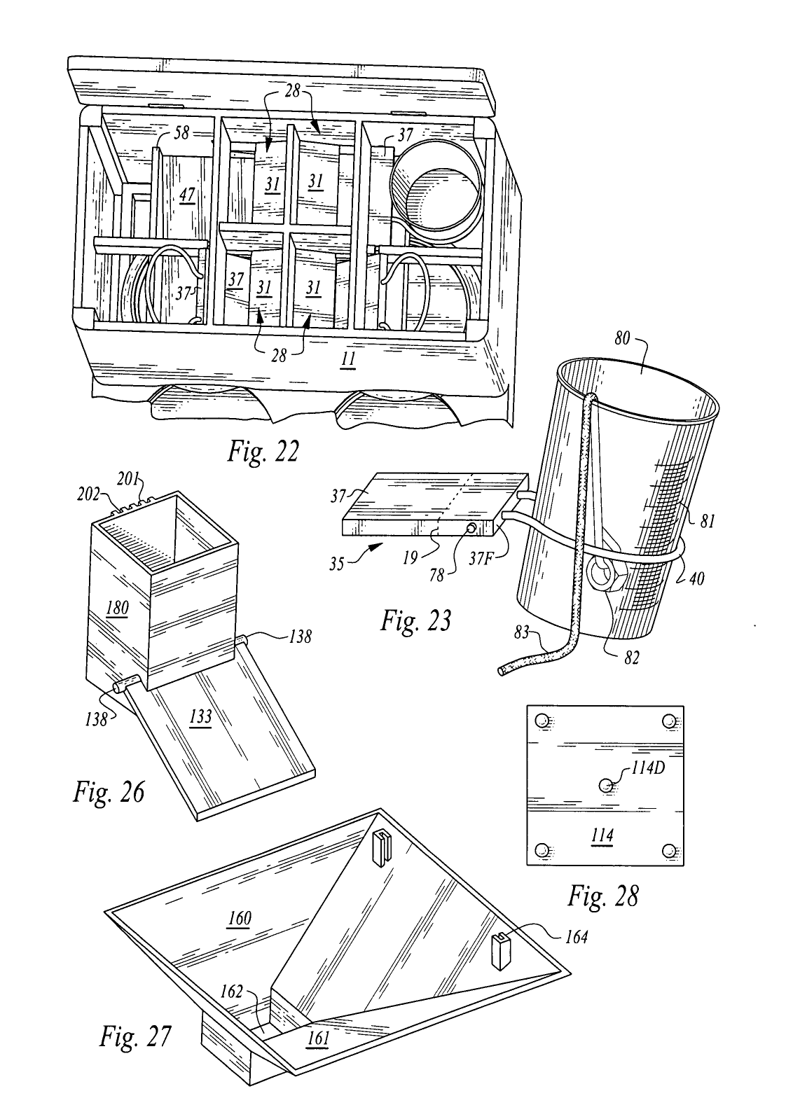

FIG. 14, FIG. 15, FIGS. 17 and 22 should all be considered together, in order to understand the path that the food pellets traverse on the way down to annular member 16 and from there to end up in the bowl 36 as noted supra.

In FIG. 14 the upper housing is seen removed from the tray 14 which is seen in the background. The rear wall 25 is seen connected to the upper and lower side walls and the braces 43 are also seen in this FIGURE. Internal wall 58 is seen to terminate prior to the bottom of the rear wall as per FIG. 14. This is because of the elevation of the annular member 16 to which internal wall 58 leads and because the purpose of wall 58 is to direct food into the annular member 16 directly below. The small food director 47 is a planar member connected to internal wall 58, rear wall 25, and large food director 45. Its purpose is to receive food pellets that fall through space 34 when the impact shelf is down due to no fluid in the vessel 80. Food pellets impact the food director 45 and fall into annular member 16. See FIG. 22 where the left rear first retainer assembly has been removed for ease of understanding of the travel path of the food pellets. Small food director 47 is mounted at about a 45-degree angle forwardly down.

Large food director 45 is disposed between the front and rear walls at a leftwardly 45-degree angle downward. Its lower edge between the front and rear walls terminates at about the same elevation as small food director 47. A gap 49 between the two food directors aforementioned is where the food pellets descend. Large food director 45 commences immediately beneath right stabilizer divider 27R, and serves to receive food pellets from the right two zones 28, denoted in FIGS. 3 & 22 and works in conjunction with the small food director 45 to deliver food pellets to the annular member 16.

The reader should again note FIG. 13 wherein only the four zones 28 are seen. While not specifically defined separately, it is readily understood that they are left front, left rear, right front and right rear. Front is the direction of the forward extension of the lower body that holds the two bowls. From FIGS. 13, 14 and 17 it can be seen that the path of the food pellets is not the same for each of the four zones. One can envision the placement of the annular receiver 16 substantially directly below the front-left zone per FIG. 13.

Food pellets from the front left zone 28 after impacting the inclined plane 31, then the pivot bar 37, fall into space 34 and then drop directly down into annular member 16 through the gap seen in FIGS. 14 and 17, which gap is in front of small food director 47.

Food pellets from the left rear zone after impacting elements 31 and 33 would fall onto small food director 47 and be directed forwardly into annular member 16.

Food pellets from the right rear zone 28 would, after impacting elements 31 and 33, are angularly directed to the large food director 45 and then into annular member 16.

Food pellets from the right front zone, after impacting elements 31 and 33 fall through the respective space 34 onto large food director 45 and then into the annular member 16.

The discussion now moves to the filling of the fluid bowl 36L. As may have been mentioned, the path into the bowl 36 for fluid is the same as for pellets in part. When the fluid falls it enters into annular member 16, through opening 16C for delivery into receiver 42 siting on an incline on tray 14, and flows through the bores 50 into the bowl 36L by gravity. One should remember that fluid can leave the vessel for the watering side of the apparatus through the use of gravity fed apertures as discussed above or by use of a wick also discussed above.

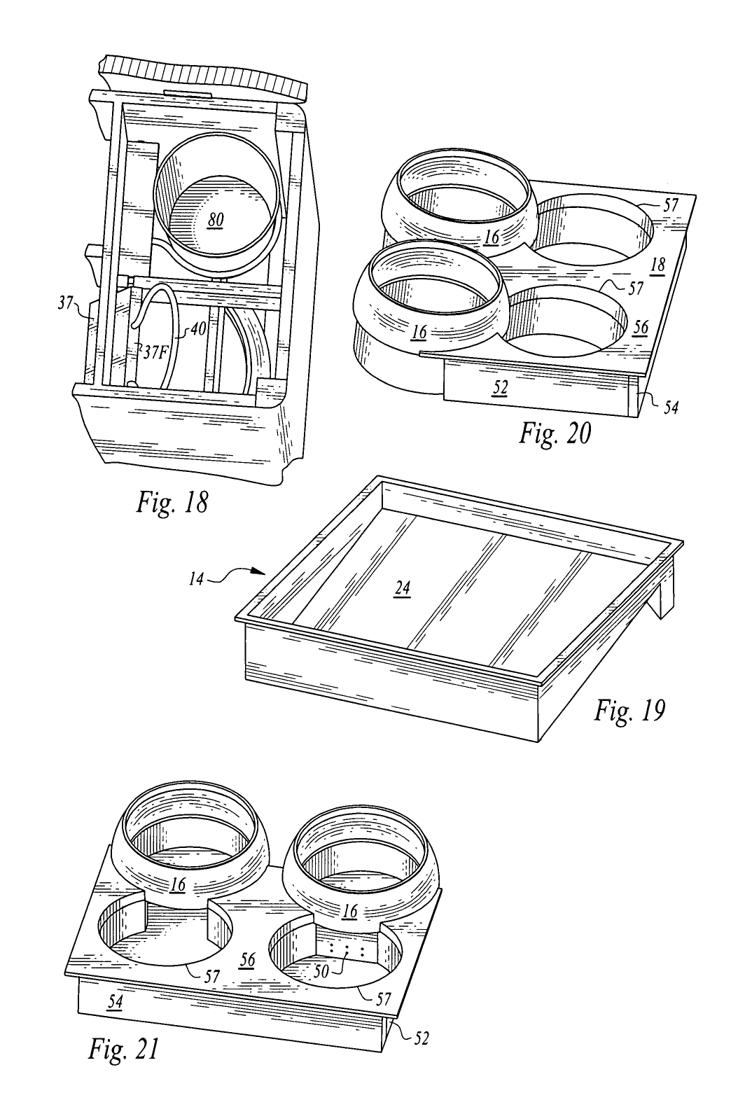

Now the discussion relates to getting the liquid to the annular member 16. As can be seen from FIGS. 5 & 14, and FIG. 17 & FIG. 18, the vessel 80 has bores or holes 84 in the base thereof such that water placed in the vessel will eventually but slowly drip through the series of holes 84 and fall directly downwardly into annular member 16 below. Thus the placement of the annular member and the receiver 42 must be coordinated to ensure that the gravity flow of fluid goes directly into the annular member 16. Wick placement may be less precise but should be net.

From FIGS. 3,4,8, and 23 it is noted that the weight, which can be a ½ inch stainless steel or brass nut to avoid water corrosion, has a wick 83 secured thereto. The wicks employed here may be cotton, polyester or a cotton blend among other fabrics and usually of a length about eight to ten inches long. Wicking action is well known and need not be discussed in detail. In any event, by placement of the end of the wick below the bottom of the respective vessel 80, fluid will flow along the wick and drop down onto the plastic tray 14 for temporary storage until disposed of. Since the food receiver 42 and the food bowl are made from materials that are water impervious, the food pellets will not be made soggy. Provision can be made for fluid to enter into the rear of the fluid receiver 42 by appropriate through bores, such that wick water can be delivered for addition to the fluid bowl 36.

By careful selection of the wick as to the material chosen and the number of strands and their diameter, time can be adjusted as to when the vessel will be emptied by wicking action. The wick in this application means the total number of strings used as described below. Volume control is one reason for the measurement indicia 81 on the side of vessel 80. The combination of water volume and the size of the wick, and material of the wick control the time for depletion of the water from vessels 80. Thus it is seen to be beneficial to have two different combinations of water volume and wick size and/material, in order to permit sequential addition of food to the food bowl. I have found that by using a finite number of ounces of water and a wick having a specific number of strands, and each wick is of a specific gauge or size in diameter that one can control the number of hours to drain the vessel. This time period can range from 4 hours, to 1 day to 4 days or more as may be desired. For each extra ounce of water added, the additional time to complete drainage is hours. By adding or removing strands to or from the wick, as well as the volume of water utilized, the time of water depletion can be controlled as well.

The apparatus of this invention is assembled and disassembled quite easily. The entire body of the apparatus can be seen in FIGS. 15 & 17. The body is merely lifted vertically from the base 12 which is seen in FIGS. 11 & 12. The support 51 described supra is readily removable from the tray 14 such that the tray can be cleaned as may be necessary due to the presence of dried fluid other than water such as milk when used as the fluid for the animal. The quoit like annular member 16 is removable from its respective receiver for easy cleaning.

### Operation

When and as the apparatus owner desires to go away for an extended period, he/she places the assembled apparatus at the desired location in the kitchen bath or elsewhere in the household. He/she then places the four vessels 80 and 80A in their respective assembly receivers 35 and fills the leftwardly ones with water to a desired fullness level as set forth by the indicia 81 on the vessel. A wick 83 chosen specifically for the desired time period, —FIG. 23— is attached to a nut 82 and placed in each of the two left side vessels with the wick 83 dangling down out of the vessel, as is known to the art. The two filled vessels cause their respective assembly first retainer's ring to rest horizontally with their respective impact bar 33 up in touch with their respective inclined plane 31, thereby NOT creating a space 34. Food pellets 120 are placed into the front and rear left zones 28. Of course food may be placed directly into the food bowl 36 as may be desired for immediate access by the animal.

Liquid such as water may be placed directly in the liquid bowl 36L if desired. Vessels 80A are placed in position in their second retainers assemblies 35, and filled with fluid, usually water. The fluid will immediately commence to drain through the apertures 84 in the bottom of the vessels 80A downwardly toward the quoit like annular member 16 and proceed downwardly into the bowl 36L as described supra.

Meantime back at the food, the water will drain downwardly into the tray 14 and cause the vessels 80 on the left side to drain, which when that condition is reached the impact bar raises creating space 34 such that the stored food pellets can fall downwardly to impact the respective food director(s) 47 and the food diverter 45 as discussed above on the way to the food bowl 36. See also FIGS. 14 and 17.

The discussion now moves to the second embodiment, which operates in the same manner using the same principles as the first embodiment. The primary difference is that many of the components of version 2 are molded plastic thus lending itself more to commercial large scale production at reasonable cost. Turning now to FIG. 24 one sees a more streamlined structure that falls with in the metes and bounds of this invention. In this second embodiment, rather than employ a wire assembly 35 to hold a separate water vessel 80, a molded water vessel 180 with an integral or adhesed impact shelf 133 is employed. See FIG. 26 where this sub-combination is illustrated. It is noted that in the second embodiment like elements are designated with like numbers but in the 100 series. Thus the designation 180 for the vessel.

Reference is now made to the engineering drawing of FIG. 24 wherein the operating principle of this invention is illustrated. Reference should also be made simultaneously to FIG. 25, a top perspective view. In FIG. 24, vessels 180 are seen to be a molded part having a series of spaced raised linear bosses 201 with a channel 202 between each boss. These channels are intended to receive the wick strings previously described to keep them neat and to make sure that they terminate below the vessel without curling upwardly. These vessels include a built in hinge 138 and an impact shelf 133. The vessel 180L is seen to contain fluid as designated by the wavy line at the top of the water. For this reason the impact shelf fits tight against the hopper. On the right side for vessel 180R, the water has drained and thus the pivot member by gravity has swung down. The wicks are not shown in this FIGURE for ease of understanding of the FIGURE.

The food delivery element 160 seen in its entirety in FIG. 27 is a funnel having 3 vertical sides normal to each other and the 4^{th} side while normal to two of the sides to present a rectangular cross section, is an inclined plane 161. Wall or side 161 serves the same function as food diverter 45 and food director 47 in FIG. 14, and also FIG. 24. The food delivery element serves the same function as the combination of parts 45 and 47; namely to deliver food to the annular ring 15 as seen in FIG. 20. Part 161 is a slot used during assembly of a totally or substantially totally plastic apparatus of the second embodiment and is non-functional with respect to usage and operation.

The reader's attention is directed to FIG. 25 wherein the vessel 180 in the lower right corner of the FIGURE is being held by a person's finger to simulate the location of the vessel 180R if it had no water therein as in FIG. 24. All of the other 3 vessels 180 are in a position similar to 180L though no water is actually present. Thus one cn see the gap between members 131 an 133 as per FIG. 24.

FIG. 28 is a bottom plan view of the tray 114 showing the built in dimples 114D, or feet for raising the tray off the ground.

### Time-Period Determination

I have found that by the careful selection of the material for the wicks and the number and size of the wicks, that I can predetermine when the desired amount of water will have exited the vessel 80 and the pivot bar will move too permit food to be delivered vertically. The wicks can be made of silk, nylon, polyester or cotton fibers, but I prefer cotton.

### Specific Examples—

#1 I used increments of 3 strings, IE. 3, 6, 9, and 12 strings of 1/16th polyester cord made by Wrights, about 18 inches long to control delivery of a 32 ounce cup of food for a large dog.

#2 For a collie who only needed 16 ounce cups of food, and which I refer to as a medium dog, I used size 3 mercerized cotton string also about 18 inches long. The more strings I used, the quicker the water was drained out of the container. 12 strings caused food drop in 1 day, 6 strings 2 days and 3 strings 4 days. It is within the skill of the art based on the information provided to select the thread and number of strings needed for the particular animal and time frame.

#3 For a small dog like a basset, cocker spaniel, who need less food, perhaps 8 oz, the number of strings can be determined. Thus 12 strings would drop 8 oz in day and 6 strings in a single day.

It is seen that doubling of the number of strings reduces the time frame by 50%. I found that the ideal string is size 10 mercerized cotton crochet thread made by JP Coates. It appears that cotton is a slower to operate wick than is polyester.

When placing the string in the water for wicking to transpire, it is important that the length of the string must end BELOW the bottom of the container 80, otherwise the container will not fully drain.

It is also seen that mathematically, that reduction of the water volume will also affect the time frame for food to drop. A 50% reduction in water volume will reduce the time for a given amount of strings by ½.

It is also within the skill of the art to determine the combination of the number of apertures and the diameter thereof to permit drainage by gravity for any predefined time period. One big problem with using the aperture method of water delivery to the trough for the animal, especially in those situations where the elapsed time is to be relatively long, and the aperture(s) are quite narrow, is the presence of calcium and other minerals in the water. The minerals cn precipitate out and clog the apertures, thus leaving the animal thirsty. One can draw the analogy to mineral deposits on the shower door.

The high cost of precision drilling, also bears consideration when doing an analysis of cost of production versus marketing price point of the apparatus.

It is seen that I have created an animal feeder and waterer, IE, water delivery unit, that can be set to deliver food and fluid to the animal at precise future times by picking the number of strands and fabric of the wicks for vessels 80 for the food, and the diameter of and number of apertures of the vessels 80A for the delivery of fluid. This apparatus permits the user to go away for a weekend or a brief vacation and know that the cat or dog will be fed, without worrying about batteries wearing out or a power failure taking place.

Thus it is seen that the release of water by wicking action, from each of the fluid containing vessels causes the respective vessel to lose content mass, IE water. For food delivery, at a critical point in time upon the loss of a finite amount of fluid, the respective second retainer assembly which holds each vessel 80, for the vessels that serve as timing devices for food delivery, and which retainer assembly is also attached to an impact shelf 33, actually moves from a first position to a second position, upward of the first position, which movement causes the attached impact shelf to move from a first position which closes off a food bin to a second position downwardly, to provide a gap between the previously touching impact shelf 33 and an adjacent inclined plane 31 to permit food pellets to fall through to the respective gap onto the food diverter 45 or the food director 47; and then ultimately through the annular member 16 for delivery to food dish 36L.

Water for the water bowl flows in a more direct path. The wicking action removes water from the water from the water vessels and delivers it down to the tray 24, FIG. 19 for entry through communication bores 50 to the water bowl 36R.

Since certain changes may be made in the described apparatus without departing from the scope of the invention herein involved, it is intended that all matter contained in the above description and shown in the accompanying drawings shall be interpreted as illustrative and not in a limiting sense

I claim:

1. An animal feed dispenser and animal water dispenser apparatus that is actuated by a diminishing water volume, which apparatus comprises:
a housing having an upper body comprising at least one fluid holding vessel, said at least one vessel each being disposed in a pivotable first retainer assembly, which retainer assembly is connected to an impact shelf that touches an inclined plane and closes off a gap there between when said vessel is full of fluid; when said first retainer assembly is in a first position;
and when a finite mass of fluid has been removed from said vessel, said pivotable first retainer assembly moves to a second position with the impact shelf away from the inclined plane, to thereby provide a gap for food to pass from a hopper disposed above the interface of said impact shelf and said inclined plane.

2. The apparatus of claim 1 wherein there are two fluid vessels, each in its own pivotable first retainer assembly.

3. The device of claim 1 further including means to deliver water to an animal to alleviate the thirst of the animal.

4. The apparatus of claim 1 in combination with a wicking means, comprising a plurality of strands of a wick attached to a weight disposed in said at least one vessel.

5. The apparatus of claim 1 wherein the upper body is disposed over a base; said base having a tray a forward slope.

6. The apparatus of claim 1 wherein there are four retainer assemblies, two first such assemblies for vessels to release food upon the vessels losing mass content, and two second vessel assemblies fixedly mounted with vessels therein for the delivery of fluid therefrom to an animal.

7. A portable non-electric animal feeding and animal water providing apparatus which apparatus comprises:
a housing disposed over a base, the housing comprising at least one food hopper, each in communication with an inclined plane and a respective impact shelf each of which shelves in first position abuts and touches the incline plane, and which impact shelf moves to a second position distant from said inclined plane, whereby food in said hopper can pass through the gap between the impact shelf and the inclined plane when said impact shelf is in its second position;
and means to move each respective impact shelf to its second position;
said impact shelf moving means comprising a vessel retainer assembly pivotally connected to each impact shelf; one for each hopper,
a first vessel for fluid retention disposed in each retainer assembly and means to deliver fluid from said at least one vessel to reduce the volume in said vessel when fluid is present.

8. The apparatus of claim 7 further including a first water delivery means disposed in said first vessel,
whereby when fluid is placed in each said first vessel, said pivotally mounted retainer assembly keeps the impact shelf in first position, and when a first wicking means is placed in position in and over the edge of each said first vessel, the wicking means moves fluid from its vessel until a finite amount of fluid is removed, at which point in time, the retainer assembly pivotally moves to its second position and the impact shelf attached thereto moves to its second position to permit food to exit from said hopper.

9. The apparatus of claim 7 further including a second pair of retainer assembles each fixedly mounted;
a second vessel for fluid disposal in each fixedly mounted retainer assembly, and second wicking means disposed in each respective vessel disposed in fixed mounted retainer assembly, each second wicking means in fluid communication with said base for delivery of fluid to a water disposed in said base, when fluid is present in said second vessels.

10. The apparatus of claim 8 wherein said base comprises a tray having upstanding walls and an inclined surface adjacent to a flat horizontal surface, said horizontal surface having a water dish disposed thereon,
said second vessels being disposed above said tray,
said water dish having a series of horizontal bores therein for fluid communication with fluid in said base when fluid is present in said base;
whereby when each said second wicking means is present in fluid added to said second vessels, fluid is removed from said second vessel, and said fluid drops onto said tray for delivery to said water dish through dish's bores.

11. The apparatus of claim 10 wherein said base has an open bottom, upstanding side and front and back walls and a to wall having a pair of openings therein for communication to each the food dish and the water dish.

12. The apparatus of claim 7 wherein the first wicking means is a weight from which is disposed a wick having at least one strand, in a generally downward disposition.

13. The apparatus of claim 10 wherein the second wicking means is also a weight having a wick attached thereto in a generally downward disposition.

14. The apparatus of claim 7 wherein the there are two feed hoppers in communication with respective impact shelves and one inclined plane, two pivotally mounted retainer assemblies each with a fluid vessel thereon, and two second vessels each disposed in fixed mounted refiner assembly.

15. An apparatus for delivery of food from food hoppers and water from a water vessel which apparatus comprises:
first and second fluid vessels, each disposed in retainer assembles,
the retainer assemblies for the food vessels being pivotally mounted to an impact shelf,
the first vessels being associated for food delivery and
the second vessels for fluid delivery being disposed in fixedly mounted refiner assemblies;
each food hopper being in communication with an impact shelf,
whereby when said pivotally mounted retainer assembly pivots, said impact shelf moves from its position touching said impact shelf to thereby permit food to exit said hopper,
and means for delivery of fluid from said fixed retainer assembly vessels to a water dish disposed at a lower elevation from said second vessels.

16. The apparatus of claim 7 wherein the body is made of plastic and the first and second vessels are plastic.

17. The apparatus of claim 9 wherein the base includes an overlain painter's try having two dishes therein, one for food and other for water;
said water dish having bores there through for the sideward ingress of fluid,
the said second wicking means delivering fluid to said tray from said second vessel, which fluid then flows into said water dish, when fluid is present in the second vessel,
and whereby when food is present in the hoppers and falls between the impact shelf and the inclined plane of said body, it falls into a food dish;
which base has a top wall comprising two openings in communication with each of the food and water dishes.

18. The apparatus of claim 17 wherein the body rests upon said tray and is removable therefrom, and each wicking means has at least one strand connected to a weight.

19. The apparatus of claim 7, further including additional retainer assemblies, each having a fluid vessel therein, and means for delivering fluid from said vessels to a water dish for an animal.

20. The apparatus of claim 10, wherein the second vessels are disposed above the inclined plane of said tray and moves by gravity to the water dish.

21. The apparatus of claim 15 wherein the means for moving fluid to the water dish is a second wicking means.
